(19) United States
(12) Patent Application Publication
(10) Pub. No.: US 2010/0057334 A1
(43) Pub. Date: Mar. 4, 2010

(54) METHOD AND SYSTEM TO ESTIMATE VEHICLE TRAFFIC CONDITIONS

(75) Inventors: Deepak Ramaswamy, Superior Township, MI (US); Sadanori Horiguchi, Novi, MI (US)

Correspondence Address: GIFFORD, KRASS, SPRINKLE,ANDERSON & CITKOWSKI, P.C, PO BOX 7021, TROY, MI, 48007-7021, US

(73) Assignee: Xanavi Informatics Corporation, Kanagawa-Ken (JP)

(21) Appl. No.: 12/201,364

(22) Filed: Aug. 29, 2008

(51) Int. Cl. G06F 19/00; H04Q 7/20

(52) U.S. Cl. 701/117; 455/456.5

(57) ABSTRACT

A method and system to estimate vehicle traffic conditions for use in a vehicle navigation system. The system includes a cellular network which receives position data from a plurality of GPS enabled cellular telephones. A processor in the cellular network is programmed to estimate the traffic conditions or density of traffic on at least one road link based upon the received position data while a transmitter at the base station then transmits that estimated traffic condition to automotive vehicles containing navigation systems. A processor in the navigation system then utilizes the estimated traffic conditions for route and/or arrival time calculations.

### BACKGROUND OF THE INVENTION

I. Field of the Invention

The present invention relates generally to vehicular navigation systems and, more particularly, to a vehicle navigation system which estimates traffic conditions.

II. Description of Related Art

The use of navigation systems is becoming increasingly prevalent in modern automotive vehicles. Such navigation systems typically contain a processor having access to a map database and utilize GPS technology in order to identify the current position of the vehicle. Such navigation systems then utilize the map database to determine a desired route and estimated time of arrival between the origin, usually current position of the vehicle, and a destination that is inputted to the navigation system by an occupant of the vehicle. Such a desired route is oftentimes the quickest route from the current position of the vehicle and to the destination, although other routes, such as scenic routes, may also be determined by the navigation system.

While the original vehicle navigation systems merely had access to the map database to calculate the desired route to the destination, modem vehicle navigation systems receive traffic flow and data from external sources, such as satellite radio, base stations and the like, and then utilize the traffic flow conditions for route and/or arrival time calculations. Such external data is obtained, for example, through cameras, probe cars, road sensors and the like.

While modem vehicle navigation systems utilize external traffic flow data in their route and arrival time calculations, such external data is typically only available for major highways, such as expressways and major roads. Conversely, no such data is currently available for minor roads and residential areas.

As a practical matter, a typical driver spends a great deal, if not most, of the driving time on side streets and residential areas for which there is currently no external traffic data available to the navigation system. As a result, the route calculations as well as the arrival time calculation of these navigation systems is less accurate than desired.

### SUMMARY OF THE PRESENT INVENTION

The present invention provides both a system and method to estimate vehicle traffic conditions for use in vehicle navigation systems to improve both the route and arrival time calculations of the navigation system.

In brief, the system of the present invention includes a cellular telephone base transciever station which receives position data from a plurality of GPS enabled cellular telephones. Such GPS enabled cellular telephones transmit the position of the telephone to the base station at regular intervals so that the base station, by processing the received data, is able to determine the density of cellular telephones in any particular given area. Such processing may occur at the base station or at a central station which receives data from a plurality of base stations.

The base/central station is also programmed to process the received data to differentiate cellular telephones that are contained within an automotive vehicle as opposed to cellular telephones that are hand carried. Such processing is performed by comparing the GPS position of the cellular telephone with map data from a map database to determine if the cellular telephone is on a road link, determining if the speed of the cellular telephone exceeds a predetermined threshold, indicative that the cellular telephone is contained within an automotive vehicle as well as the altitude of the cellular telephone relative to the road link. After such processing, the data from the cellular telephones that are hand carried are disregarded which results in a good estimation of the density of the vehicle carried cellular telephones in a particular area and along particular road links.

A transmitter at the base station then transmits the estimated traffic conditions to automotive vehicles in that area which contain a navigation system. A processor in the navigation system then utilizes the density of traffic for the various road links for route and/or arrival time calculations. That information is then conveyed to occupants of the automotive vehicle, typically through a display screen or by voice simulator.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating the collection of local traffic data by a base station;

FIG. 2 is a diagrammatic view illustrating a vehicle with a navigation system;

FIG. 3 is a view illustrating an exemplary data format for the transmission between the base station and the cellular telephones;

FIG. 4 is a block diagrammatic view illustrating a vehicle navigation system;

FIG. 5 is a flowchart illustrating the operation apart of the present invention;

FIG. 6 is a flowchart illustrating the use of the data by a vehicle navigation system;

FIG. 7 is a block diagrammatic view illustrating yet another aspect of the present invention; and

FIG. 8 is a flowchart illustrating the operation of the navigation system of FIG. 7.

### DETAILED DESCRIPTION OF A PREFERRED EMBODIMENT OF THE PRESENT INVENTION

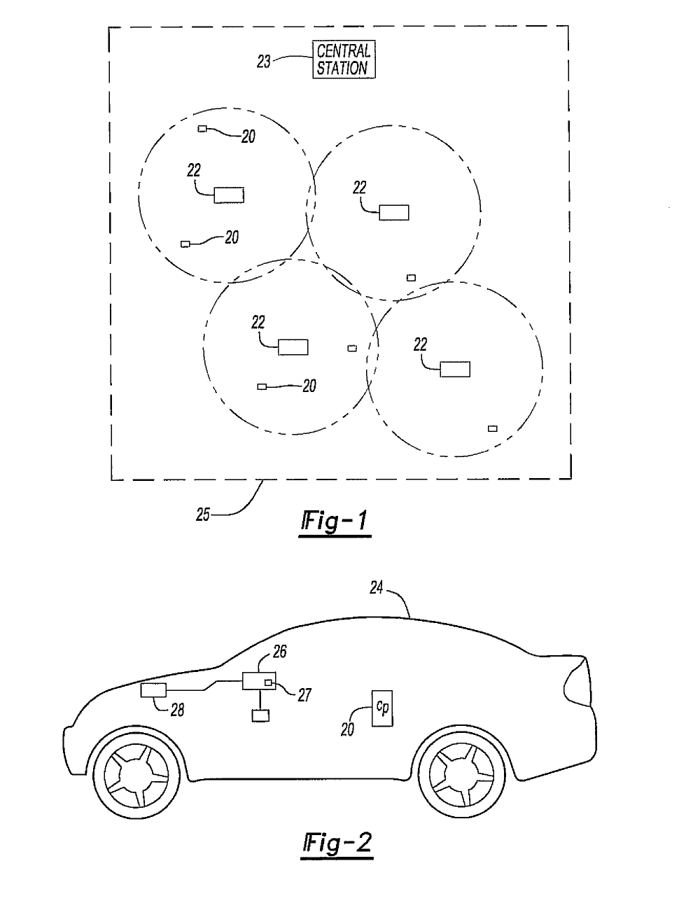

With reference first to FIG. 1, in order to implement the method and system of the present invention, a plurality of GPS or assisted GPS (AGPS) enabled cellular telephones 20 periodically transmit position data to a cellular telephone base station 22. The area serviced by the base station 22 is preferably limited, e.g. the area within a few miles of the base station 22 and typically a plurality of base stations 22 communicate with a central station 23 in a cellular network 25. Furthermore, as used in this specification a GPS or assisted GPS enabled cellular telephone means either a cellular telephone having internal GPS capability or a cellular telephone which communicates with a GPS device, such as a navigation system, to obtain GPS data.

In many situations, the cellular telephones 20 may not have a clear view towards the GPS satellites. Consequently, when the AGPS enabled cellular telephone detects that the signals from the satellites are weak or inferior and cannot be used to clearly identify the location of the cellular telephone, the cellular telephone 20 contacts the base station 22 to request satellite orbital data from the station 22. The base station 22, which is typically within a few miles of the cellular telephone 20 as indicated by the circles in FIG. 1, transmits the satellite orbital data to the cellular telephone 20 requesting the satellite orbital data.

The satellite orbital data from the base station 22 is typically valid for approximately four hours. Consequently, the base station 22 routinely updates the satellite orbital data for transmission upon request to the AGPS enabled cellular telephone. The cellular telephone 20, once the satellite orbital data is received from the base station 22, is able to then calculate its position for subsequent retransmission to the base station 22.

With reference now to FIG. 2, although the cellular telephone 20 may be hand carried, the cellular telephone 20 may also be contained within an automotive vehicle 24 having a navigation system 26. The navigation system 26 preferably receives not only signals from the GPS satellites to determine the position of the vehicle, but also inputs from other sensors 28, such as an accelerometer, gyroscope and other electrorics which provide indication of not only the position but also the direction of travel for the vehicle 24. The vehicle navigation system 26 then communicates through a wireless technology, such as Bluetooth, the position and optionally other data such as the direction and acceleration of the vehicle 24 to the GPS enabled cellular telephone 20. Alternatively, the cellular telephone 20 may be self-contained in the navigation system 26. The cellular telephone 20 then communicates the position of the vehicle 24, and optionally the direction, speed and acceleration of the vehicle 24, to the base station 22.

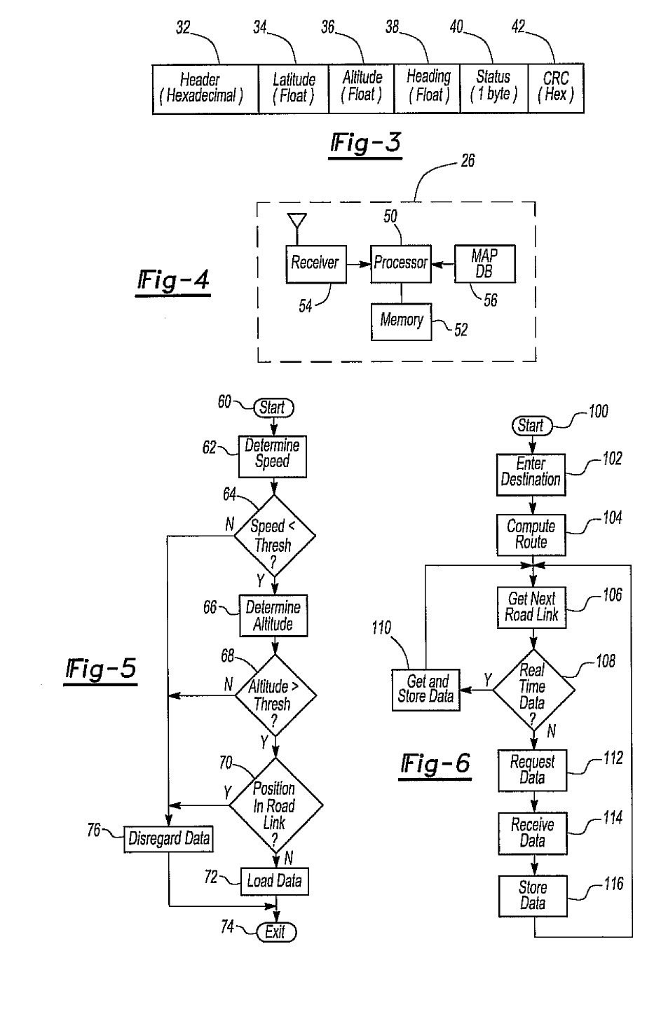

Although any data format may be utilized by the cellular telephone 20 to transmit the position and, if available, the speed and direction of travel of the vehicle 24 to the base station 22, an exemplary data format is shown in FIG. 3. The data format includes a header 30 containing a predetermined number of bytes, e.g. two four-byte sequences, that are unique and unlikely to be repeated as real data. For example, the header could comprise 0xAB 0xBA 0xAB 0xBA. It would be unlikely that such a sequence could constitute actual data so that the receipt of the header sequence is indicative to the base station 22 that data follows the header 30.

After the header, a four-byte sequence for both the latitude 32 and longitude 34 of the cellular telephone 22 is transmitted followed by an additional four bytes of data indicative of the altitude 36 of the cellular telephone. A heading 38 of the vehicle 24, if available, would then follow followed by a short status byte 40. The status byte 40 would, for example, indicate if the data was derived from a vehicle navigation system 26, and thus highly reliable, or from a GPS or AGPS assisted enabled cellular telephone 20 not associated with a navigation system 26. The status byte 40 is then followed by a checksum 42 to enable the base station 22 or central station 23 to verify the accuracy of the received data by the base station 22.

With reference now to FIG. 4, cellular network 25 includes a processor 50 which is operating under the control of a program stored in memory 52. A receiver 54 in the base station 26 receives the position data transmitted by the various cellular telephones 20 within the local area of the base station 22. The cellular network 25 also includes a map database 56 containing the various road links at least in the local area to the base stations 22 in the network 25.

Utilizing the data received by the receiver 54, the processor 50 is able to determine the location and density of cellular telephones within the local area of each base station 22. However, for maximum accuracy, it is highly desirable to differentiate between cellular telephones 20 that are hand carried and those cellular telephones 20 that are contained within an automotive vehicle 24 (FIG. 2).

With reference now to FIG. 5, in order to differentiate between cellular telephones within an automotive vehicle and those that are hand carried, the processor 50 is programmed to initiate a differentiation routine starting at step 60. Step 60 then proceeds to step 62.

At step 62, the processor 50 determines the speed of the individual cellular telephone based upon multiple sequential transmissions of the position data from each cellular telephone 20 to the base station 26. Step 62 then proceeds to step 64.

At step 64, the processor 50 compares the speed determined at step 62 with a predetermined speed threshold. If the speed of the cellular telephone 20 is less than the speed threshold, e.g. two miles per hour, it is indicative that the cellular telephone 20 is hand carried rather than in an automotive vehicle. In that case, step 64 proceeds to step 66 where the data from that particular cellular telephone is disregarded in subsequent processing by the base station 26.

Conversely, if the speed determined at step 62 is greater than the speed threshold, step 64 instead proceeds to step 66 where the altitude of the cellular telephone 20 is determined. Step 66 then proceeds to step 68.

At step 68, the altitude of the cellular telephone determined at step 66 is compared against an altitude threshold. If the altitude of the cellular telephone exceeds the altitude threshold, e.g. two meters, indicative that the cellular telephone is contained within a multistory building, step 68 branches to step 66 to disregard the data. Otherwise, step 68 proceeds to step 70.

At step 70, the processor 50 in the base station 26 accesses the map database 56 (FIG. 4) to determine if the position of the cellular telephone is within a road link contained in the map database 56. If not, indicative that the cellular telephone is positioned in a location other than a road link, step 70 branches to step 66 and disregards the data. Otherwise, step 70 branches to step 72 where the data is tagged as good traffic data. Step 72 then proceeds to step 74 which exits the routine.

In the above fashion, the cellular network 25 is able to determine, with good accuracy, the number or density of GPS enabled cellular telephones on road links within the access area for each base station 22. The cellular network 25 then communicates that information to the base station 22 which transmits that information to the vehicle navigation system 26. Consequently, the vehicle navigation system 26 has access to vehicle congestion or vehicle traffic conditions along road local links for which traffic data would not otherwise be available.

With reference now to FIG. 6, an exemplary operation of a vehicle navigation system 26 is illustrated. The navigation system 26 includes a processor 27 (FIG. 2) which, under program control, calculates not only desired route information, but also time of arrival at the destination.

The vehicle navigation system 26 initiates its processing at step 100 and then proceeds to step 102 where the user inputs the desired destination to the navigation system 26. Any conventional means may be used, such as a touch screen, mouse, keyboard or the like may be used to input the destination. Step 102 then proceeds to step 104.

At step 104, the navigation system computes the route to the desired destination entered at step 102 utilizing conventional navigation techniques. The computed route at step 104 will consist of a series of sequential road links from the origin, typically the position of the vehicle, and to the destination. Step 104 then proceeds to step 106.

At step 106, the program obtains the first road link determined at step 104 and then proceeds to step 108. At step 108, the program determines if real time traffic data is available for the road link, since real time data is oftentimes available for major highways and expressways and constitutes the most reliable data. If so, step 108 branches to step 110 where the real time data is obtained and stored for subsequent calculation. Step 110 then branches back to step 106 and obtains the data for the next road link until the entire route is processed.

Conversely, if real time data is not available for the road link, step 108 instead branches to step 112 where the navigation system sends a data request for the road link by the cellular telephone to the base station 22. Step 112 then proceeds to step 114 where the navigation system 26 receives the data from the base station 22 via the cellular telephone 20 of data for the current road link being processed. That data is then stored for subsequent use in calculations at step 116 and step 116 proceeds back to step 106. Consequently, steps 106-116 are reiterated until all of the road links in the route between the origin or position of the vehicle and the destination are processed. The navigation system 26 then utilizes this information to calculate the estimated arrival time of the vehicle at the destination. Additionally, the navigation system 26 may utilize this information to reroute or recalculate the desired route in order to avoid traffic congestion.

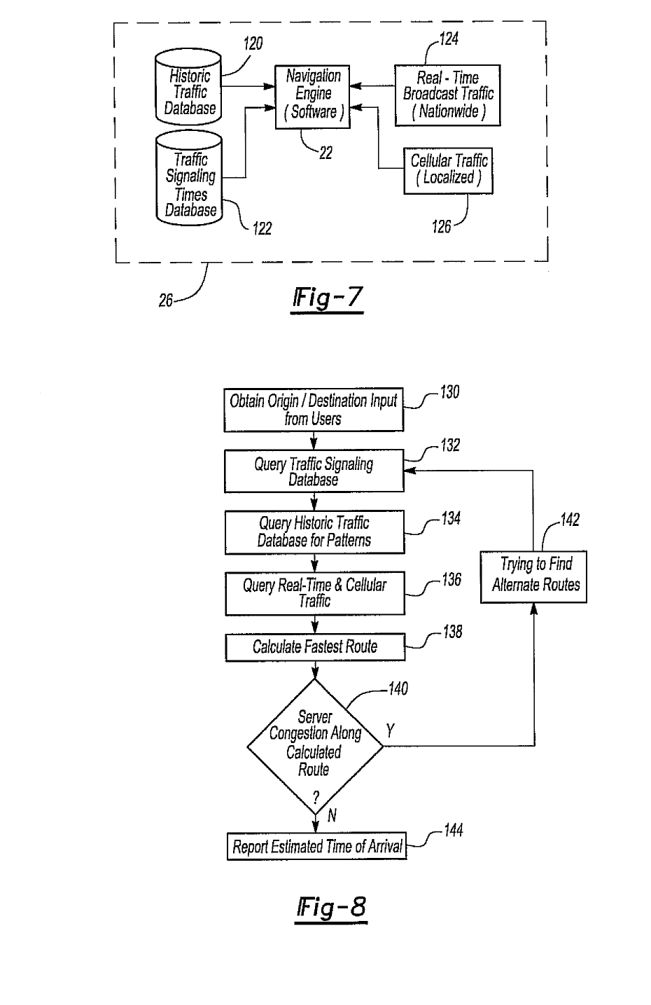

With reference now to FIG. 7, as a further enhancement of the present invention, the vehicle navigation system 26 includes not only a historic or statistical traffic database 120, but also a traffic signal database 122 which contains time and duration of actuation on one or more traffic lights along one or more road links. The traffic signal database 122 is particularly important along certain routes where the traffic lights are prioritized depending upon the day and/or time of day.

The processor 27 also receives real time traffic data 124 for major highways as well as the traffic data for local road links as previously discussed.

With reference now to FIG. 8, an exemplary program is illustrated of the operation of the navigation system 26 having a traffic signal database 122. At step 130 the processor 27 receives the origin/destination input from the users or occupants of the vehicle. Typically, a touch screen is used to input the vehicle destination, although other means, such as a keyboard or mouse, etc. may also be used. Step 130 then proceeds to step 132.

At step 132 the program queries the traffic signal database 122 for road link information between the origin and the destination. Step 132 then proceeds to step 134 where the processor 27 queries the historic traffic database 120 for traffic patterns of road links along the calculated route to the destination. Step 134 then proceeds to step 136.

At step 136, the processor 27 queries both the real time traffic as well as the localized traffic utilizing the data from cellular telephones as previously described. Step 136 then proceeds to step 138.

At step 138, the processor 27 in the navigation system 26 calculates the fastest or most desirable route and arrival time to the destination using conventional route calculation techniques. Step 138 then proceeds to step 140 which determines if there is severe congestion along the calculated route. If so, step 140 calculates an alternative route at step 142 and then proceeds back to step 132 where the above process is repeated. Otherwise, step 140 branches to step 144 where the navigation system notifies the occupants of the vehicle of the estimated arrival time. Typically, this is done by either voice simulation or displaying the estimated arrival time on the display screen for the navigation system.

From the foregoing, it can be seen that the present invention provides a novel vehicular navigation system which accounts for not only traffic flow along major highways, but also traffic flow or traffic density along smaller road links. Having described our invention, however, many modifications thereto will become apparent to those skilled in the art to which it pertains without deviation from the spirit of the invention as defined by the scope of the appended claims.

We claim:

1. A system to estimate vehicle traffic conditions for use in a vehicle navigation system comprising:
a cellular network which receives position data from a plurality of GPS enabled cellular telephones,
a cellular network processor programmed to estimate traffic conditions on at least one road link based on said position data,
a transmitter which transmits said estimated traffic conditions to automotive vehicles containing a navigation system,
a navigation processor contained in said navigation systems which utilize said estimated traffic conditions for route and/or arrival time calculations.

2. The invention as defined in claim 1 wherein said cellular network processor is programmed to identify and disregard received position data from cellular telephones that are not in an automotive vehicle.

3. The invention as defined in claim 2 wherein said cellular network processor compares the received position data with a map database and disregards the received position data indicative of a position outside of a road link in said map database.

4. The invention as defined in claim 2 wherein said cellular network processor calculates the rate of travel of the cellular telephone and disregards the received position data from that cellular telephone when the rate of travel is less than a predetermined threshold.

5. The invention as defined in claim 2 wherein said cellular network processor calculates the altitude of the cellular telephone and disregards the received position data from that cellular telephone when the altitude is greater than a predetermined threshold.

6. The invention as defined in claim 1 wherein the cellular network processor utilizes assisted GPS to identify the position of the received data from the cellular telephones.

7. The invention as defined in claim 2 wherein the position data transmitted by the cellular telephones contains data which differentiates vehicle contained cellular telephones from non vehicle contained cellular telephones and wherein said cellular network processor processes data from only non vehicle contained cellular telephones to identify and disregard received data from cellular telephones that are not contained in an automotive vehicle.

8. The invention as defined in claim 1 and comprising a traffic signal database containing data on the actuation of at least one traffic signal on at least one road link accessible by said cellular network processor for estimating traffic conditions.

9. A method to estimate traffic conditions for use in vehicle navigation systems comprising the steps of:
receiving position data from GPS enabled cellular telephones in a cellular network,
said cellular network estimating traffic conditions along at least one road link based on the received position data,
transmitting the estimated traffic conditions to automotive vehicles containing navigation systems,
said navigation systems utilizing the transmitted estimated traffic conditions in route and/or arrival time calculations.

10. The invention as defined in claim 9 and further comprising the step of identifying and disregarding cellular network received position data that are not contained in a vehicle.

11. The invention as defined in claim 10 wherein said identifying and disregarding step further comprises the step of comparing the received position data with a map database in the cellular network and disregarding position data which falls outside road links contained in said map database.

12. The invention as defined in claim 10 wherein said identifying and disregarding step further comprises the step of computing the speed of the cellular telephone and disregarding position data from cellular telephones traveling below a preset speed threshold.

13. The invention as defined in claim 10 wherein said identifying and disregarding step further comprises the step of determining the altitude of the cellular telephone and disregarding position data from cellular telephones above a preset altitude threshold relative to a road link aligned with the received position data.

14. The invention as defined in claim 9 and comprising the step of utilizing assisted GPS at the base station to determine the position of the cellular telephone.

15. The invention as defined in claim 9 wherein said estimating traffic conditions step comprises the step of accessing a traffic signal database containing data on the actuation of at least one traffic signal on at least one road link.
